(19) United States
(12) Patent Application Publication
(10) Pub. No.: US 2011/0300370 A1
(43) Pub. Date: Dec. 8, 2011

(54) COATING METHOD AND COATED ARTICLE

(75) Inventors: Yasuhiro Yoshida, Tokyo (JP); Yoshinori Yamamoto, Tokyo (JP); Teruhiko Kumada, Tokyo (JP); Reiji Morioka, Tokyo (JP)

(73) Assignee: MITSUBISHI ELECTRIC CORPORATION, Tokyo (JP)

(21) Appl. No.: 13/201,316

(22) PCT Filed: Feb. 8, 2010
(86) PCT No.: PCT/JP10/51793

§ 371 Date: Aug. 12, 2011

(30) Foreign Application Priority Data
Feb. 13, 2009 (JP) 2009-031673

(51) Int. Cl. B32B 3/26; B05D 3/02

(52) U.S. Cl. 428/320.2; 427/373

(57) ABSTRACT

Provided is a coating method, including the steps of: applying a coating composition including inorganic fine particles and fluororesin particles in an aqueous medium onto a material to be coated; drying the coating composition on the material to be coated to remove the aqueous medium, thereby forming a porous film formed of the inorganic fine particles, the porous film having the fluororesin particles therein and having voids; and applying one or more water-soluble substances selected from the group consisting of a water-soluble surfactant and a water-soluble polymer onto the porous film, thereby filling the one or more water-soluble substances in the voids of the porous film. According to the coating method, there can be formed a coated article having a coating film which exhibits the excellent effect for inhibiting the attachment of oil stains for a long period and from which, even if oil stains are attached, the oil stains can be easily removed by wiping or washing with water.

### TECHNICAL FIELD

The present invention relates to a coating method and a coated article, in particular, to a coating method for providing a coating film which exhibits an excellent effect for inhibiting the attachment of oil stains for a long period, and from which oil stains can be removed by wiping or washing with water, and a coated article coated with the coating film.

### BACKGROUND ART

In kitchens, factories, and the like, oil stains occur from oil mist and the like attaching to the surfaces of various articles, causing articles to become unsightly and in some cases causing sanitation problems such as bad odors. Thus, in recent years, a wide range of developments have been made in coating technologies for inhibiting the attachment of oil stains to the surfaces of articles. Specifically, a method of forming a coating film on the surface of articles by using a coating composition prepared by blending a hydroxyl-group-containing silicone-based additive and/or a hydroxyl-group-containing fluorine-based additive in a powder coating material containing a polyester resin and a blocked isocyanate (see, for example, Patent Document 1) and a method of forming a coating film on the surface of each article by using a coating composition prepared by blending a specific fluorosilicone compound as a coating material modifier in a coating material (see, for example, Patent Document 2) has been proposed. In addition, a method of forming a coating film by applying an undercoating material containing water glass, a hardening agent for water glass, and an aggregate onto the surface of articles, thereby forming an undercoating layer, and then applying a topcoating material containing water glass and silica fine particles but not containing a hardening agent for water glass onto the undercoating layer, thereby forming a topcoating layer, followed by firing (see, for example, Patent Document 3), and a method of forming a coating film on the surface of articles by using a resin composition containing a fluorine-based oligomer having a plurality of predetermined water-repellent groups and hydrophilic groups in its molecule (see, for example, Patent Document 4) have been proposed. Further, a method of decomposing oil stains attached to the surfaces of articles by using a photocatalyst (see, for example, Patent Document 5) has also been proposed.

### Citation List

### Patent Documents

Patent Document 1: JP 09-53026 A

Patent Document 2: JP 08-60030 A Patent Document 3: JP 2006-152221 A Patent Document 4: JP 2009-127015 A Patent Document 5: JP 09-4900 A

### DISCLOSURE OF THE INVENTION

### Problems to be Solved by the Invention

However, although conventional coating technologies have been able to provide an effect for inhibiting the attachment of oil stains, until now the coating technologies have had the problem that attached oil stains cannot be removed satisfactorily, and the problem that the effect for inhibiting the attachment of oil stains is difficult to maintain for a long period.

Generally, the attachment of oil stains occurs on both hydrophobic (water-repellent) oil-repellent coating films such as fluororesin films and hydrophilic (oil-repellent) coating films such as hydrophilic resin films. When a hydrophobic film is used as a coating film, oil is likely to adhere easily to the film, and hence oil stains are more liable to attach to the film, moreover, it is difficult to remove the attached oil stains by wiping or washing with water. When a fluororesin film or the like is used as a coating film, the degree of attachment of oil stains is less compared with the case of using a general hydrophobic coating film, but it is still difficult to remove oil stains attached to the surfaces of articles by wiping or washing with water to the same extent as the case where a general hydrophobic coating film is used. On the other hand, when a hydrophilic film is used as a coating film, oil stains may get into the minute concave portions on the surface of the film or hydrophilic groups may chemically react with oil, making it difficult to remove the attached oil stains by wiping or washing with water in some cases.

Further, oil stains attached to the surfaces of articles can be removed at the time of wiping or washing with water by using a water based cleaning solution containing a surfactant. However, when reaction such as oxidation progress as time passes, resulting in the attachments of oil stains, not only washing with water but also wiping oil stains per se often becomes difficult. Thus, it may become necessary to clean oil stains by using alkalis, solvents, or the like.

Although a technology for decomposing oil stains by using a photocatalyst exhibits a good effect on the attachment of very small amounts of oil stains, it does not provide a sufficient effect on the attachment of large amounts of oil stains.

The present invention has been made to solve the problems described above, and an object of the invention is to provide a coating method capable of forming a coating film which exhibits an excellent effect for inhibiting the attachment of oil stains for a long period and from which, even if oil stains are attached, the oil stains can be easily removed by wiping or washing with water.

In addition, another object of the present invention is to provide a coated article having a coating film which exhibits an excellent effect for inhibiting the attachment of oil stains for a long period and from which, even if oil stains are attached, the oil stains can be easily removed by wiping or washing with water.

### Means for Solving the Problems

The inventors of the present invention have intensively studied to solve the problems described above. Consequently, the inventors have found that it is possible to provide a coating film which exhibits an excellent effect for inhibiting the attachment of oil stains for a long period and from which, even if oil stains are attached, the oil stains can be easily removed by wiping or washing with water, by filling the voids of a porous film with a predetermined water-soluble substance formed of inorganic fine particles with fluororesin particles dispersed therein.

That is, the present invention is a coating method, including the steps of: applying a coating composition including inorganic fine particles and fluororesin particles in an aqueous medium onto a material to be coated; drying the coating composition on the material to be coated to remove the aqueous medium, thereby forming a porous film formed of inorganic fine particles, the porous film having the fluororesin particles dispersed therein and having voids; and applying one or more water-soluble substances selected from the group consisting of a water-soluble surfactant and a water-soluble polymer onto the porous film, thereby filling the voids of the porous film with one or more of the water-soluble substances.

Further, the present invention is a coated article, including a coating film comprising a porous film formed of inorganic fine particles with fluororesin particles dispersed in the porous film, and one or more water-soluble substances selected from the group consisting of a water-soluble surfactant and a water-soluble polymer, the water-soluble substances filling the voids of the porous film.

### Effects of the Invention

According to the present invention, a coating method capable of forming a coating film which exhibits an excellent effect for inhibiting the attachment of oil stains for a long period and from which, even if oil stains are attached, the oil stains can be easily removed by wiping or washing with water can be provided. According to the present invention, a coated article having a coating film which exhibits an excellent effect for inhibiting the attachment of oil stains for a long period and from which, even if oil stains are attached, the oil stains can be easily removed by wiping or washing with water can also be provided.

### MODES FOR CARRYING OUT THE INVENTION

### Embodiment 1

A coating method of the present invention includes the steps of: applying a predetermined coating composition onto a material to be coated; drying the coating composition on the material to be coated, thereby forming a predetermined porous film; and applying a predetermined water-soluble substance onto the porous film, to fill the voids of the porous film.

The coating composition that is used in the coating method of the present invention includes inorganic fine particles and fluororesin particles in an aqueous medium.

The inorganic fine particles are the components for forming the porous film. The inorganic particles are not particularly limited as long as the inorganic particles are capable of forming a porous film. Examples thereof include metal fine particles of elements such as silicon, magnesium, aluminum, titanium, cerium, tin, zinc, germanium, indium, and antimony, and fine particles of oxides and nitrides of those elements. These fine particles may be used on their own, or as a mixture thereof.

Further, from the viewpoint of enhancing the bonding force between the inorganic fine particles in the porous film, it may be possible to add, to the coating composition, a common binder such as a sol of a metal oxide such as silica or alumina, any of the various silicates such as sodium silicate and lithium silicate, a metal alkylate, aluminum phosphate, or [symbol] -alumina. Although, if a binder including inorganic fine particles is used, the binder may be used alone.

The average particle diameter of the inorganic fine particles is not particularly limited. When the average particle diameter is 20 nm or less, a porous film having high strength can be formed by drying or heating even if a binder is not added. For example, a porous film having a relatively high strength can be formed by simply drying, at room temperature, silica fine particles having an average particle diameter of 20 nm or less. Here, the term “average particle diameter” herein means the average value of particle diameter values obtained by performing particle size distribution measurement by a laser diffraction/scattering method.

The content of the inorganic fine particles in the coating composition is not particularly limited and is preferably 0.5 mass % to 60 mass %, more preferably 1 mass % to 40 mass %. Here, the mass of the inorganic fine particles varies depending on its dried state or the like, and hence, after the coating composition is dried at 100° C., to evaporating water sufficiently, the mass is measured, and the resultant mass is defined as the mass of the inorganic fine particles (hereinafter, the mass of the inorganic fine particles has the same meaning as described above). When the content of the inorganic fine particles is less than 0.5 mass %, the thickness of the resultant porous film becomes too thin. Thus, the amount of water-soluble substance filling the porous film becomes small, with the result that attached oil stains cannot be removed sufficiently by wiping or washing with water in some cases. On the other hand, when the content of the inorganic fine particles is more than 60 mass %, the thickness of the resultant porous film becomes too thick, sometimes resulting in the occurrence of defects such as cracks in the porous film.

The fluororesin particles are the components that impart dirt prevention properties to the porous film formed of the inorganic fine particles. When the fluororesin particles are contained in the coating composition, the fluororesin particles are dispersed in the porous film formed of the inorganic fine particles. The porous film has a surface in which the fluororesin particles are dispersed and exposed, hence it is difficult for both hydrophilic and hydrophobic substances to attach thereto. Thus, the porous film can inhibit not only the attachment of oil mist causing oil stains directly but also the attachment of dust and the like which promotes the attachment of oil mist indirectly. Further, because the fluororesin particles are dispersed and exposed on the surface of the porous film, even in the case that oil stains are attached to the porous film, the oil stains can be easily removed at the time of wiping or washing with water, and the reattachment of oil stains can also be inhibited. In particular, the fluororesin particles are also components that impart lubricity to the porous film, and hence the effectiveness of wiping oil stains can be further improved.

The fluororesin particles are not particularly limited and examples thereof include polytetrafluoroethylene (PTFE), a tetrafluoroethylene-hexafluoropropylene copolymer (FEP), a tetrafluoroethylene-perfluoroalkyl vinyl ether copolymer (PFA), a fluorinated ethylene-vinyl ether copolymer (FEVE), an ethylene-tetrafluoroethylene copolymer (ETFE), an ethylene-chlorotrifluoroethylene copolymer (ECTFE), a polyvinylidene fluoride (PVDF), polychlorotrifluoroethylene (PCTFE), polyvinyl fluoride (PVF), copolymers thereof, and mixtures thereof, and particles formed from mixtures of those fluororesins with other resins and the like.

The average particle diameter of the fluororesin particles is not particularly limited and is preferably 0.05 μm to 200 μm, more preferably 0.1 μm to 80 μm. When the average particle diameter of the water-insoluble polymer particles is less than 0.05 μm, the hydrophobic portion in the porous film becomes smaller. As a result, the effect of inhibiting the attachment of oil stains is not exerted sufficiently in some cases. On the other hand, when the average particle diameter of the water-insoluble polymer particles is more than 200 μm, the unevenness of the surface of the porous film becomes larger. As a result, dust, powder dust, and the like easily attach to the surfaces, sometimes promoting the attachment of oil stains.

The content of the fluororesin particles in the coating composition is not particularly limited and is preferably 5 parts by mass to 70 parts by mass, more preferably 10 parts by mass to 50 parts by mass with respect to 100 parts by mass of the inorganic fine particles. When the content of the fluororesin particles is less than 5 parts by mass, the effect of inhibiting the attachment of oil stains is not exerted sufficiently in some cases. On the other hand, when the content of the fluororesin particles is more than 70 parts by mass, oil stains may easily attach to the coating film. Note that because the fluororesin particles are a nonvolatile component, the content of the fluororesin particles in the coating composition described above is identical to the content of the fluororesin particles in the coating film.

In order to form a porous film having fluororesin particles dispersed therein, the fluororesin particles need to be dispersed in the coating composition. Thus, the coating composition is preferably produced by blending a dispersion prepared by dispersing the fluororesin particles in water using the effect of hydrophilic groups contained in a surfactant or the fluororesin particles. This method of blending the dispersion in the coating composition is the simplest method of producing the coating composition, but the coating composition can also be produced by directly blending the fluororesin particles into the coating composition, thereby causing self-emulsification, or by dispersing the fluororesin particles in the coating composition with a homogenizer or the like.

The coating composition includes an aqueous medium, in addition to the above-mentioned inorganic fine particles and fluororesin particles. The kind of aqueous medium is not particularly limited and is preferably water. Alternatively, it is also possible to use, as the aqueous medium, a mixture of water and a polar solvent compatible with water.

The kind of water is not particularly limited. However, in the case in which the water has a large mineral content, if the average particle diameter of the inorganic fine particles such as silica is small or if the concentration of the inorganic fine particles is high, some of the inorganic fine particles may aggregate. Thus, the use of deionized water is preferred. However, if the inorganic fine particles do not aggregate, tap water or the like may be used instead.

Examples of the polar solvent include: alcohols such as ethanol, methanol, 2-propanol, and butanol; ketones such as acetone, methyl ethyl ketone, and diacetone alcohol; esters such as ethyl acetate, methyl acetate, cellosolve acetate, methyl lactate, ethyl lactate, and butyl lactate; ethers such as methyl cellosolve, cellosolve, butyl cellosolve, and dioxane; glycols such as ethylene glycol, diethylene glycol, and propylene glycol; glycol ethers such as diethylene glycol monomethyl ether, triethylene glycol monomethyl ether, propylene glycol monomethyl ether, and 3-methoxy-3-methyl-1-butanol; and glycol esters such as ethylene glycol monomethyl ether acetate, propylene glycol monomethyl ether acetate, diethylene glycol monobutyl ether acetate, and diethylene glycol monoethyl ether acetate.

The content of the aqueous medium in the coating composition is not particularly limited, and should be adjusted appropriately depending on the coating method or the like, and is generally 40 mass % to 99.5 mass %.

Oil stains attached to the surfaces of articles are fixed to the surfaces of the articles by air oxidation, photoreaction, and the like, as time passes, sometimes resulting in difficulty in removing oil stains by wiping or washing with water. Thus, by including an antioxidant in the coating film, it is possible to prevent oil stains from adhering to the surfaces of articles.

The term “antioxidant” herein means a component that prevents oil stains from transforming through oxidation caused by heat or light in the presence of oxygen, and includes a radical scavenger that scavenges radicals occurring in the process of the deterioration of the oil stains, a peroxide decomposer that decomposes peroxides produced in oil stains, thereby stabilizing the oil stains, and an ultraviolet absorber that inhibits the photoreaction inducing the oxidation reaction.

Any method of including an antioxidant in the coating film can be used without any particular limitation. For example, the antioxidant can be blended into coating composition, or once the porous film has been formed the antioxidant can be used to fill the voids of the porous film.

The antioxidant is not particularly limited and examples thereof include: hydroquinone; 2,6-di-t-butyl-p-cresol; dibutylhydroxytoluene (BHT); butylhydroxyanisole (BHA); phenol-based compounds such as 2,6-di-t-butyl-4-ethylphenol, 2,2-methylene-bis-(4-methyl-6-t-butylphenol), n-octadecyl 3-(3,5-di-t-butyl-4-hydroxyphenyl)propionate, 1,1,3-tris-(2-methyl-4-hydroxy-5-t-butylphenyl)butane, and tris(3,5-di-t-butyl-4-hydroxybenzyl) isocyanurate; sulfur-based compounds such as dilauryl thiodipropionate; phosphorus-based compounds such as triphenyl phosphite; amine-based compounds such as phenothiazine; ascorbic acid; ascorbic acid salts; ascorbic acid stearate; erythorbic acid; erythorbic acid salts; propyl gallate; and tocopherol. These may be used on their own, or as a mixture thereof.

When the antioxidant is blended in the coating composition, the content thereof is not particularly limited. The content is preferably 0.05 part by mass 30 parts by mass, more preferably 0.5 part by mass to 15 parts by mass with respect to 100 parts by mass of the inorganic fine particles. When the content of the antioxidant is less than 0.05 part by mass, effects provided by including the antioxidant are not sufficiently exerted in some cases. On the other hand, when the content of the antioxidant is more than 30 parts by mass, the strength of the resultant coating film becomes too low in some cases. Note that because the antioxidant is a nonvolatile component, the content of the antioxidant in the coating composition described above is identical to the content of the antioxidant in the coating film.

Further, the coating composition can include, in addition to the above-mentioned components, other components necessary for imparting desired characteristics. The type of other components is not particularly limited and it is possible to use various types of components that can be generally blended into a coating composition. Examples of the other components include a surfactant with the purpose of improving coatability, an antibacterial agent and an antimold agent with the purpose of inhibiting the occurrence of bacteria and mold at the time of storing the coating composition, an organic viscosity adjuster such as a water-soluble polymer and an inorganic viscosity adjuster such as montmorillonite both aimed at adjusting the viscosity of the composition, an organic solvent aimed at adjusting the stability, coatability, and drying characteristics of a coating composition suitably, and a pigment aimed at coloring the coating film.

The content of the other components in the coating composition varies according to the type of the other components, and hence their content needs to be appropriately selected depending on the other components that are used. In general, the content of the other components in the coating composition is preferably 10 parts by mass or less, more preferably 5 parts by mass or less with respect to 100 parts by mass of the inorganic fine particles. When the content of the other components is more than 10 parts by mass, the strength of the resultant coating film becomes too low in some cases.

Further, any method of blending the other components can be used without any particular limitation, and the other components can be blended according to any known method. Specifically, the other components should be blended into the coating composition and mixed.

Any method of applying a coating composition onto a material to be coated can be adopted without any particular limitation, and the coating composition can be applied by using, for example, a dipping method, a brush, or any of various coaters. Alternatively, the coating composition can also be applied onto a material to be coated by pouring. By using any of these methods, the coating composition can be applied onto a material to be coated without producing any defects.

When the coating composition is applied onto a material to be coated in order to obtain a porous film having less unevenness, after the coating composition has been applied to the material to be coated, the excess coating composition can be removed by blowing in an air current. Further, when the coating composition is applied onto a material to be coated by a dipping method, the unevenness of the resultant porous film caused by the flow-down of the coating composition can be prevented by slowly drawing up the material to be coated. Furthermore, when the coating composition is applied onto a material to be coated by the dipping method, it may be possible to apply the coating composition onto the material to be coated, and then, for example, to rotate the material to be coated, thereby removing the excess coating composition by spinning it out.

On the other hand, when it is difficult to perform application or the like by using a dipping method, a brush, or any of the various coaters, it can be preferable to perform coating by spraying. When the coating method of spraying is performed, as minute unevenness is formed on the resultant porous film, it is possible to prevent the occurrence of discoloration caused by a thin porous film.

However, when it is necessary to more reliably avoid the blur (fluctuation) of the porous film, or to make the thickness of the porous film larger, the above-mentioned coating method may be performed repeatedly. Further, in order to improve the adhesion of the coating composition to the material to be coated and to decrease the amounts of a surfactant and the like blended, it may be possible to perform pretreatment such as UV treatment, corona treatment, flame treatment, or chromic acid treatment on the material to be coated before the coating composition is applied onto the material to be coated.

A method of drying the coating composition applied onto a material to be coated can be appropriately selected according to the kind of inorganic fine particles and the like. For example, the coating composition can be dried at room temperature or dried by heating.

In general, when the inorganic fine particles can be solidified at room temperature, the coating composition can be dried at room temperature. In contrast, when the inorganic fine particles are difficult to solidify at room temperature, the coating composition needs to be dried by heating. Further, even if the inorganic fine particles are solidified at room temperature, when drying is performed at room temperature (when heating is not performed), it may take a certain period of time for the inorganic fine particles to solidify, and hence the coating composition may be dried by heating from the viewpoint of shortening the time that it takes to form the resultant porous film.

When the coating composition is dried by heating, the heating temperature is preferably 40° C. to 250° C., more preferably 45° C. to 200° C. When the heating temperature is less than 40° C., the inorganic fine particles do not become solidified satisfactorily in some cases. On the other hand, when the heating temperature is more than 250° C., properties of the fluororesin particles may change. Further, the heating time is preferably 10 minutes or more, more preferably 30 minutes or more. When the heating time is less than 10 minutes, the inorganic fine particles do not solidify satisfactorily in some cases. Note that, a material having low heat conductivity, such as a resin, a thin steel plate having a thickness of 0.2 mm or less, or the like, is used as the material to be coated the inorganic fine particles may be solidified by heating for just 30 seconds or more.

The porous film formed as described above has fluororesin particles uniformly dispersed therein and has voids.

In order for this porous film to be filled sufficiently with the water-soluble substance, the percent of voids within the porous film is preferably 5% to 70%, more preferably 10% to 60%. When the percent of voids is less than 5%, the amount of the water-soluble substance that can be filled into the porous film becomes smaller, and consequently, attached oil stains cannot be sufficiently removed by wiping or washing with water in some cases. On the other hand, when the percent of voids is more than 70%, the strength of the porous film is sometimes reduced.

Furthermore, in order for the porous film to be filled sufficiently with a water-soluble substance, the thickness of the porous film is preferably 0.1 μm to 250 μm. When the thickness is less than 0.1 μm, the amount of the water-soluble substance that can be filled into the porous film becomes smaller, and consequently, attached oil stains cannot be sufficiently removed by wiping or washing with water in some cases. On the other hand, when the thickness is more than 250 μm, the porous film is too thick, sometimes resulting in the detachment of the porous film from a material to be coated.

The water-soluble substance is used for filling the voids of the porous film.

Here, when a coating film is formed by using a coating composition containing a water-soluble substance, sufficient strength is not provided by the film. In contrast, according to the coating method of the present invention, a porous film with excellent strength is formed, and following this a water-soluble substance is applied to the porous film, thus the water-soluble substance can be used to fill the voids of the porous film while the sufficient film strength is maintained.

The water-soluble substance is a water-soluble polymer or a water-soluble surfactant which has the characteristics of not dissolving in oil stains and not having deliquescent properties. They can be used individually or in combination. A substance which dissolves in oil stains is not preferred, because, after oil stains have attached to it, the oil stain will diffuse inside it. Further, a substance having deliquescent property is not preferred, because, when a coated article on which a coating film has been formed is in use, the substance may form an aqueous solution, resulting in the substance running away.

Further, the water-soluble substance preferably has a characteristic of low crystallization properties. This is because it is difficult to uniformly fill the voids of the porous film with a substance having high crystallization properties. However, even if a substance having high crystallization property is used, as is it sometimes difficult for substances to crystallize in the voids of a porous film, in these cases substances having high crystallization properties may also be used.

The water-soluble substance has a hydrophilic group and has a boiling point of or a decomposition point of preferably 150° C. or more, more preferably 200° C. or more. When the boiling point or the decomposition point of the water-soluble substance is less than 150° C., the water-soluble substance disappears or deteriorates through evaporation or decomposition, and attached oil stains sometimes cannot be removed sufficiently by wiping or washing with water, though this occurrence may depend on the environment of use.

The water-soluble substance fills the voids of the porous film, and partially covers the surface of the porous film. When oil stains are attached to the surface of the porous film, the water-soluble substance filling the voids of the porous film has the effect of inhibiting the oil stains entrance into the inside of the porous film. Further, the water-soluble substance covering the surface of the porous film has the effect of preventing the oil stains from binding to the surface of the porous film. Further, because the water-soluble substance has hydrophilicity, the water-soluble substance also has the effect of inhibiting the attachment per se of oil stains caused by oil mist. Further, these effects act in a synergistic manner, and consequently, the effect of inhibiting the attachment of oil stains is maintained over a long period, and even if oil stains are attached, the oil stains can be easily removed by wiping or washing with water.

When oil stains are removed by wiping, part of the water-soluble substance is also removed with the oil stains. However, the amount of the water-soluble substance removed by the wiping is very small, and hence the above-mentioned effects are sustainable. Likewise, when oil stains are removed by washing with water, part of the water-soluble substance is dissolved in water and removed. However, as water-soluble substance fills the voids of the porous film, the flow-out rate of the water-soluble substance is very slow. Thus, even after several times of washing with water, the above-mentioned effects are sustainable.

When a water-soluble polymer is used as the water-soluble substance, the water-soluble polymer swells and slowly diffuses at the time of washing with water, and as a result, dissolves in water. Thus, the water-soluble polymer has the effect of detaching oil stains by floating them up, the effect of inhibiting the reattachment of detached oil stains, and has an excellent ability to remove oil stains by washing with water. Further, when the water-soluble polymer is filled into the voids of a porous film, the chance that the coating of the water-soluble polymer on the surface of the porous film is incomplete due to crystallization or the like is very small, so the water-soluble polymer can be effectively coated on the surface of the porous film and can be effectively fill the voids of the porous film.

Examples of a water-soluble polymer having such characteristics as described above include polyvinyl alcohol, polyvinyl pyrrolidone, polyethylene glycol, polyvinyl acetate, polyacrylic acid and a salt thereof, polyacrylamide and a copolymer thereof, and a mixture of those polymers. In particular, the water-soluble polymer preferably has an average polymerization degree of 50 or more from the viewpoint of washing property. When the average polymerization degree of the water-soluble polymer is less than 50, its properties as a polymer are not sufficiently exerted, and consequently, good cleaning properties are difficult to provide in some cases.

Further, when the water-soluble polymer is used as the water-soluble substance, a cross-linking agent may be used with the water-soluble polymer. By using the cross-linking agent with the water-soluble polymer, the water solubility of the water-soluble polymer lowers, and the flow-out rate of the water-soluble polymer at the time of washing with water can be inhibited. As a result, even if washing with water is carried out multiple times, the effect of inhibiting the attachment of oil stains and the effect of removing oil stains are not easily deduced.

Any cross-linking agent can be used without any particular limitation, and a cross-linking agent can be selected depending on the kind of a water-soluble polymer that is used. Examples of the cross-linking agent include: polyvalent metal compounds such as zirconium carbonate and aluminum sulfate; adipic acid dihydrazide; glyoxal and a reaction product thereof; and a compound having a cross-linkable functional group such as an oxazoline group, a carbodiimide group, an isocyanate group, or an aziridine group.

When the cross-linking agent is used, the amount of the cross-linking agent blended is preferably 5 parts by mass or less with respect to 100 parts by mass of the water-soluble polymer. When the amount of the cross-linking agent blended is more than 5 parts by mass, the cross-linking reaction between the water-soluble polymer and the cross-linking agent progresses too far. As a result, the water-soluble polymer does not easily dissolve in water at the time of washing with water, and consequently, the effect of inhibiting the attachment of oil stains and the effect of removing oil stains may be sometimes reduced.

Further, in general, when a water-soluble substance has a lower molecular weight, the water-soluble substance diffuses in water faster. Thus, while the water-soluble substance contacts with cleaning water, floating oil stains up, the amount of the water-soluble substance diffusing in the cleaning water becomes larger. In particular, when a thinner coating film is formed, a water-soluble substance having a lower molecular weight sometimes does not provide the effect of improving the washing properties of the film.

However, if the water-soluble substance having a lower molecular weight is a water-soluble surfactant, good washing properties are provided. This is because the water-soluble surfactant has the effect of removing oil and inhibiting the reattachment of the removed oil by adsorbing onto its surface. Further, the water-soluble surfactant has the effect of making the surface tension of water less, and hence water removal at the time of washing with water improves, resulting in the inhibition of excessive flow-out of the water-soluble substance caused by its contact with water for a long time. Furthermore, the water-soluble surfactant resists crystallization and is able to fill the voids of the porous film well.

Examples of the water-soluble surfactant include: anionic surfactants such as a fatty acid sodium, a monoalkyl sulfate salt, an alkyl polyoxyethylene sulfate salt, an alkylbenzenesulfonic acid salt, and a monoalkyl phosphate salt; cationic surfactants such as an alkyltrimethylammonium salt, a dialkyldimethylammonium salt, and an alkylbenzyldimethylammonium salt; amphoteric surfactants such as an alkyldimethylamine oxide and an alkylcarboxybetaine; and nonionic surfactants such as a polyoxyethylene alkyl ether, a polyoxyethylene-polyoxypropylene graft polymer, a fatty acid sorbitan ester, an alkyl polyglucoside, a fatty acid diethanolamide, and an alkyl monoglyceryl ether.

Note that, if the HLB value of the surfactant can be defined, the HLB value of the surfactant is preferably 6 or more, more preferably 8 or more. When the HLB value of the surfactant is less than 6, the surfactant has low hydrophilicity (low water solubility), and hence, when oil stains are attached, the surfactant, for example, dissolves in oil, sometimes resulting in it being unable to provide good washing properties.

For the method of applying the coating composition to a material to be coated, any method of applying a water-soluble substance onto a porous film can be adopted without any particular limitation, and the water-soluble substance can be applied by using, for example, a spraying method, a dipping method, a brush, or any of the various coaters.

Specifically, it is recommended that a solution be prepared by dissolving the water-soluble substance in a solvent such as water or an alcohol, and then, this solution be applied onto the porous film, or the porous film be immersed in this solution. On the other hand, when the water-soluble substance is in the form of a liquid or a paste, it is recommended that the water-soluble substance be directly applied to the porous film, or the porous film be directly immersed in the water-soluble substance. In addition, when the water-soluble substance is applied onto a porous film formed on a portion upon which it is difficult to perform the application of the water-soluble substance on, such as a portion with a complicated shape, a wall surface, or a ceiling surface, it may be possible to adjust the fluidity of an application solution by adding bubbles or particles.

Further, when the coating film formed by using the coating method of the present invention is subjected to wiping or washing with water many times in order to remove oil stains, some of the water-soluble substance in the coating film runs away, sometimes resulting in the reduction of the effect of removing oil stains and the effect of preventing the attachment of oil stains. In this case, it is possible to regenerate the coating film by filling the voids of the coating film with a water-soluble substance in the same manner as that in the above-mentioned method. It is possible to apply the water-soluble substance to the coating film in a wet state after the coating film has been wiped or washed with water. However, when a water-soluble surfactant having relatively low hydrophilicity or a water-soluble polymer having a very large molecular weight is applied, it is better to dry a coating film and then apply the water-soluble substance, because the water-soluble substance is more easily able to fill the voids of the coating film when it is dry. Further, by including the water-soluble substance in the cleaning water itself, it is possible to carry out, the removal of oil stains from the coating film and the application of the water-soluble substance onto the coating film at the same time.

Further, a method of drying the water-soluble substance applied to the coating film should be appropriately selected according to the kind of water-soluble substance and the like. For example, the water-soluble substance may be dried at room temperature or dried by heating if necessary.

The amount of the water-soluble substance filling the coating film is preferably 5 parts by mass to 250 parts by mass, more preferably 20 parts by mass to 200 parts by mass with respect to 100 parts by mass of the inorganic fine particles, from the viewpoint of ensuring oil stain washing properties. When the amount of the water-soluble substance filled is less than 5 parts by mass, the effect of removing oil stains sometimes is not sufficiently provided. On the other hand, when the amount of the water-soluble substance filled is more than the amount that is sufficient for fully filling the voids of the coating film, a large amount of the water-soluble substance is present on the surface of the coating film, and the whole surface of the coating film may be covered with the water-soluble substance. Even if such a state occurs, there are no problems with the oil stain washing properties, but when the content of the water-soluble substance is more than 250 parts by mass, the film of the water-soluble substance formed on the surface of the coating film may be detached or the article may become unsightly.

Further, the amount of the water-soluble substance filling the coating film is preferably 5 parts by mass to 120 parts by mass, more preferably 20 parts by mass to 100 parts by mass with respect to 100 parts by mass of the inorganic fine particles, for the purpose of ensuring the oil stain washing properties and oil stain dirt prevention properties. When the amount of the water-soluble substance filled is less than 5 parts by mass, the effect of removing oil stains is sometimes not sufficiently provided. On the other hand, when the amount of the water-soluble substance filled is more than 120 parts by mass, the fluororesin particles and the like are covered with the water-soluble substance, and hence the desired dirt prevention properties are sometimes not provided.

When the water-soluble substance is applied onto a porous film, an antioxidant can be applied with the water-soluble substance from the viewpoint of preventing oil stains from being fixed to the surface of an article, as described above. In particular, in the case where the antioxidant is water-soluble, a mixture of the water-soluble substance and the antioxidant can be applied onto the porous film, and hence the number of steps required in the coating method can be reduced compared with the case where those substances are separately applied onto a porous film. Note that, when both the substances are applied separately, the antioxidant should be dissolved in a solvent and the resultant solution should be applied onto the porous film.

Any method of drying the water-soluble substance or the like applied onto a porous film may be adopted without any particular limitation. The water-soluble substance or the like may be dried by leaving it to stand at room temperature. Alternatively, it is also possible to perform drying by heating if necessary.

The coating film formed by the above-mentioned coating method comprises a porous film formed of inorganic fine particles and having voids, with fluororesin particles dispersed in the porous film, and a predetermined water-soluble substance (and any antioxidant) filling the voids of the porous film. This coating film mainly comprises the porous film formed of inorganic fine particles and the water-soluble substance filling the voids of the porous film, hence the whole film is hydrophilic and resists the attachment of oil. Further, although the porous film has voids, as the voids are filled with the water-soluble substance, oil stains can be prevented from entering the voids, and thus removing oil stains by wiping or washing with water is not difficult. In addition, the water-soluble substance dissolves in water at the time of washing with water, thereby promoting the removal of attached oil stains. In particular, even in the case where the amount of the water-soluble substance filling the voids is small and oil stains are present in the voids, the oil stains can be removed from the voids by virtue of the expansion in volume of the water-soluble substance that takes place when the water-soluble substance dissolves in water.

### Embodiment 2

A coated article of the present invention has a coating film formed by the above-mentioned coating method. That is, the coated article of the present invention has a coating film which includes a porous film formed of inorganic fine particles and having voids, with fluororesin particles dispersed in the porous film, and a predetermined water-soluble substance filling the voids of the porous film.

This coating film can be formed on any article without any particular limitation and can be used on articles in a wide range of applications. Examples of the articles include kitchen equipment (such as range hoods and gas ranges), air conditioners, and plant facilities, in all of which the attachment of oil stains is recognized as a problem.

### EXAMPLES

The details of the present invention are hereinafter described with reference to examples, but the present invention is not restricted to the examples.

### Example 1

A coating composition was prepared by adding colloidal silica containing silica fine particles (inorganic fine particles) having an average particle diameter of 85 nm, colloidal silica containing silica fine particles (inorganic fine particles) having an average particle diameter of 5 nm, and PTFE particles (fluororesin particles) having an average particle diameter of 0.3 μm to deionized water, followed by mixing, and further adding polyoxyethylene lauryl ether (a surfactant) to the mixture, followed by mixing. Here, in the coating composition, the content of the silica fine particles having an average particle diameter of 85 nm was controlled to 4 mass %, the content of the silica fine particles having an average particle diameter of 5 nm was controlled to 1 mass %, and the content of the surfactant was controlled to 0.05 mass %. Further, the content of the PTFE particles was controlled to 6 to 7 parts by mass with respect 100 parts by mass of the total silica fine particles.

A stainless-steel plate was immersed in the resultant coating composition, this was slowly drawn up, and dried at 100° C. for 30 minutes, thereby forming a porous film (film thickness: 0.8 μm). The stainless-steel plate on which the porous film was formed was immersed in an aqueous solution containing 2 mass % polyvinyl pyrrolidone. Next, the stainless-steel plate was drawn up from the aqueous solution, and excess aqueous solution was shaken off, followed by drying at room temperature, in order to form a coating film filled with polyvinyl pyrrolidone. Here, the content of polyvinyl pyrrolidone of the coating film was controlled to 30 parts by mass with respect to 100 parts by mass of the silica fine particles.

### Examples 2 to 4

A stainless-steel plate on which a coating film was formed was prepared in each of Examples 2 to 4 in the same manner as that in Example 1, except that the thickness of the porous film was changed and the kind and type of water-soluble substance filling the voids of the porous film was changed. The thickness of the porous film was adjusted by, for example, increasing or decreasing the number of applications of the coating composition onto the stainless-steel plate.

In Example 2, polyethylene glycol (polymerization degree: 4,000) was used as the water-soluble substance, and a stainless-steel plate on which a porous film (film thickness: 1.0 μm) was formed was immersed in an aqueous solution containing 2 mass % polyethylene glycol, followed by drying at room temperature, in order to form a coating film. The content of polyethylene glycol in the coating film was controlled to 45 parts by mass with respect to 100 parts by mass of the silica fine particles.

In Example 3, sodium lauryl sulfate was used as the water-soluble substance, and a stainless-steel plate on which a porous film (film thickness: 0.5 μm) was formed was immersed in an aqueous solution containing 2 mass % sodium lauryl sulfate, followed by drying at room temperature, in order to form a coating film. The content of sodium lauryl sulfate in the coating film was controlled to 32 parts by mass with respect to 100 parts by mass of the silica fine particles.

In Example 4, a polyoxyethylene-polyoxypropylene block polymer (ADEKA Pluronic L-64, ADEKA CORPORATION) was used as the water-soluble substance, and a stainless-steel plate on which a porous film (film thickness: 0.8 μm) was formed was immersed in an aqueous solution containing a 2 mass % polyoxyethylene-polyoxypropylene block polymer, followed by drying at room temperature, in order to form a coating film. The content of the polyoxyethylene-polyoxypropylene block polymer in the coating film was controlled to 35 parts by mass with respect to 100 parts by mass of the silica fine particles.

### Example 5

A coating composition was prepared by adding an alumina powder (inorganic fine particles) having an average particle diameter of 0.5 μm, Ethyl silicate 48 (inorganic fine particles, Colcoat Co., Ltd.), PTFE particles (fluororesin particles) having an average particle diameter of 0.3 μm, phosphoric acid, and polyethylene glycol lauryl ether (a surfactant) to deionized water, followed by mixing. Here, in the coating composition, the content of the alumina particles having an average particle diameter of 0.5 um was controlled to 5 mass %, the content of Ethyl silicate 48 was controlled to 1 mass %, the content of phosphoric acid was controlled to 0.2 mass %, and the content of the surfactant was controlled to 0.05 mass %. Further the content of the PTFE particles was controlled to 7 parts by mass with respect 100 parts by mass of the total inorganic fine particles.

The resultant coating composition was applied onto a stainless-steel plate by spray coating, and was dried at 150° C. for 30 minutes, thereby forming a porous film (film thickness: 2.1 μm). The stainless-steel plate on which the porous film was formed was immersed in an aqueous solution containing 2 mass % polyvinyl pyrrolidone. Next, the stainless-steel plate was drawn up from the aqueous solution, and excess aqueous solution was shaken off, followed by drying at room temperature, in order to form a coating film filled with polyvinyl pyrrolidone. Here, the content of polyvinyl pyrrolidone in the coating film was controlled to 50 parts by mass with respect to 100 parts by mass of the inorganic fine particles.

### Examples 6 and 7

A stainless-steel plate on which a coating film was formed was prepared in each of Examples 6 and 7 in the same manner as that in Example 5, except that the thickness of the porous film was changed and the kind and type of the water-soluble substance filling the voids of the porous film were changed. The thickness of the porous film was adjusted by, for example, increasing or decreasing the number of applications of the coating composition onto the stainless-steel plate.

In Example 6, sorbitan lauryl ester (ADEKA TOL S-20, ADEKA CORPORATION) was used as the water-soluble substance, and a stainless-steel plate on which a porous film (film thickness: 3.0 μm) was formed was immersed in an aqueous solution containing 2 mass % sorbitan lauryl ester, followed by drying at room temperature, in order to form a coating film. The content of sorbitan lauryl ester in the coating film was controlled to 62 parts by mass with respect to 100 parts by mass of the inorganic fine particles.

In Example 7, a polyoxyethylene-polyoxypropylene block polymer (ADEKA Pluronic L-64, ADEKA CORPORATION) was used as the water-soluble substance, and a stainless-steel plate on which a porous film (film thickness: 3.2 μm) was formed was immersed in an aqueous solution containing a 2 mass % polyoxyethylene-polyoxypropylene block polymer, followed by drying at room temperature, in order to form a coating film. The content of the polyoxyethylene-polyoxypropylene block polymer in the coating film was controlled to 58 parts by mass with respect to 100 parts by mass of the inorganic fine particles.

### Comparative Example 1

In Comparative Example 1, only a coating film of inorganic fine particles was formed, and no water-soluble substance was filled.

A coating composition was prepared by adding colloidal silica containing silica fine particles (inorganic fine particles) having an average particle diameter of 85 nm and colloidal silica containing silica fine particles (inorganic fine particles) having an average particle diameter of 5 nm to deionized water, followed by mixing, and further adding polyoxyethylene lauryl ether (a surfactant) to the mixture, followed by mixing. Here, in the coating composition, the content of the silica fine particles having an average particle diameter of 85 nm was controlled to 4 mass %, the content of the silica fine particles having an average particle diameter of 5 nm was controlled to 1 mass %, and the content of the surfactant was controlled to 0.05 mass %.

A stainless-steel plate was immersed in the resultant coating composition, this was slowly drawn up, and dried at 100° C. for 30 minutes, in order to form a coating film (film thickness: 1.0 μm).

### Comparative Example 2

In Comparative Example 2, a coating film only formed of inorganic fine particles was filled with a water-soluble substance.

A stainless-steel plate on which a porous film (film thickness: 0.5 μm) was formed according to the same procedure as that in Comparative Example 1 this was immersed in an aqueous solution containing 2 mass % polyvinyl pyrrolidone. Next, the stainless-steel plate was drawn up from the aqueous solution, and the excess aqueous solution was shaken off, followed by drying at room temperature, in order to form a coating film filled with polyvinyl pyrrolidone. Here, the content of polyvinyl pyrrolidone of the coating film was controlled to 30 parts by mass with respect to 100 parts by mass of the silica fine particles.

### Comparative Example 3

In Comparative Example 3, a coating film which was formed of inorganic fine particles and fluororesin particles to which no water-soluble substance was filled.

A coating composition was prepared by adding colloidal silica containing silica fine particles (inorganic fine particles) having an average particle diameter of 85 nm, colloidal silica containing silica fine particles (inorganic fine particles) having an average particle diameter of 5 nm, and PTFE particles (fluororesin particles) having an average particle diameter of 0.3 μm to deionized water, followed by mixing, and further adding polyoxyethylene lauryl ether (a surfactant) to the mixture, followed by mixing. Here, in the coating composition, the content of the silica fine particles having an average particle diameter of 85 nm was controlled to 4 mass %, the content of the silica fine particles having an average particle diameter of 5 nm was controlled to 1 mass %, and the content of the surfactant was controlled to 0.05 mass %. Further, the content of the PTFE particles was controlled to 9 parts by mass with respect 100 parts by mass of the total silica fine particles.

A stainless-steel plate was immersed in the resultant coating composition, slowly drawn up, and dried at 100° C. for 30 minutes, in order to form a coating film (film thickness: 0.8 μm).

Each of the stainless-steel plates prepared in Examples 1 to 7 and Comparative Examples 1 to 3 were exposed for 5 minutes to oil smoke produced by heating vegetable oil on a hot plate, to produce oil stains. Then, the attached oil stains were dissolved with hexane, and the resultant solution was collected and subjected to liquid chromatography to perform quantitative determination. Next, each of the stainless-steel plates which were prepared in the same manner as described above and to which oil stains were attached were washed by being immersed in water at 40° C. for 30 seconds. After that, in the same manner as described above, the remaining oil stains were dissolved with hexane, and the resultant solution was collected and subjected to liquid chromatography to perform quantitative determination. Table 1 shows the results.

TABLE 1

| | | | | Amount of attached oil | |
|---|---|---|---|---|---|
| | | | | (mg/dm²) | |
| | | Fluororesin | Water-soluble | Before washing | After washing |
| | Inorganic fine particles | particles | substance | with water | with water |
| Example 1 | Silica fine particles | PTFE | Polyvinyl pyrrolidone | 25 | 6 |
| Example 2 | Silica fine particles | PTFE | Polyethylene glycol | 34 | 5 |
| Example 3 | Silica fine particles | PTFE | Sodium lauryl sulfate | 38 | 2 |
| Example 4 | Silica fine particles | PTFE | Polyoxyethylene- | 19 | 2 |
| | | | polyoxypropylene | | |
| | | | block polymer | | |
| Example 5 | Alumina powder | PTFE | Polyvinyl pyrrolidone | 78 | 7 |
| | Ethyl silicate 48 | | | | |
| Example 6 | Alumina powder | PTFE | Sorbitan lauryl ester | 85 | 8 |
| | Ethyl silicate 48 | | | | |
| Example 7 | Alumina powder | PTFE | Polyoxyethylene- | 69 | 4 |
| | Ethyl silicate 48 | | polyoxypropylene | | |
| | | | block polymer | | |
| Comparative | Silica fine particles | — | — | 120 | 105 |
| Example 1 | | | | | |
| Comparative | Silica fine particles | — | Polyvinyl pyrrolidone | 135 | 62 |
| Example 2 | | | | | |
| Comparative | Silica fine particles | PTFE | — | 15 | 10 |
| Example 3 | | | | | |

As shown in Table 1, the results of each of the stainless-steel plates prepared in Examples 1 to 7 show that the amount of attached oil stains was small and the attached oil stains were easily removed by washing with water. In contrast, the results of the stainless-steel plate prepared in Comparative Example 1 (a coating film containing no fluororesin particle and no water-soluble substance) showed that the amount of attached oil stains was large and the attached oil stains were not sufficiently removed by washing with water. Further, the results of the stainless-steel plate prepared in Comparative Example 2 (a coating film containing no fluororesin particle) showed that the amount of attached oil stains was large, but the amount of the attached oil stains removed by washing with water was larger. The results of the stainless-steel plate prepared in Comparative Example 3 (a coating film containing no water-soluble substance) showed that, though the amount of attached oil stains was small, the amount of the attached oil stains removed by washing with water was small. Therefore, it is possible to conclude that, when a coating film contains no fluororesin particles, the effect of preventing the attachment of oil stains is not sufficiently provided, and when a coating film contains no water-soluble substance, the effect of removing oil stains is not sufficiently provided.

### Example 8

A stainless-steel plate on which the same porous film as that prepared in Example 4 was formed was immersed in an aqueous solution containing 2 mass % polyvinyl pyrrolidone and 0.1 mass % dibutylhydroxytoluene (an antioxidant). Next, the stainless-steel plate was drawn up from the aqueous solution, and the excess aqueous solution was shaken off, followed by drying at room temperature, in order to form a coating film filled with polyvinyl pyrrolidone and dibutylhydroxytoluene. Here, in the coating film, the content of polyvinyl pyrrolidone was controlled to 30 parts by mass with respect to 100 parts by mass of the silica fine particles, and the content of dibutylhydroxytoluene was controlled to 1.5 parts by mass with respect to 100 parts by mass of the silica fine particles.

### Examples 9 to 11

A stainless-steel plate on which a coating film was formed was prepared in each of Examples 9 to 11 in the same manner as that in Example 8, except that the kind and type of antioxidant were changed.

In Example 9, tocopherol was used as the antioxidant, and a stainless-steel plate on which a porous film was formed was immersed in an aqueous solution containing 2 mass % polyvinyl pyrrolidone and 0.2 mass % tocopherol, followed by drying at room temperature, in order to form a coating film. Here, in the coating film, the content of polyvinyl pyrrolidone was controlled to 30 parts by mass with respect to 100 parts by mass of the silica fine particles, and the content of tocopherol was controlled to 3 parts by mass with respect to 100 parts by mass of the silica fine particles.

In Example 10, hydroquinone was used as the antioxidant, and a stainless-steel plate on which a porous film was formed was immersed in an aqueous solution containing 2 mass % polyvinyl pyrrolidone and 1 mass % hydroquinone, followed by drying at room temperature, in order to form a coating film. Here, in the coating film, the content of polyvinyl pyrrolidone was controlled to 30 parts by mass with respect to 100 parts by mass of the silica fine particles, and the content of hydroquinone was controlled to 15 parts by mass with respect to 100 parts by mass of the silica fine particles.

In Example 11, sodium erythorbate was used as the antioxidant, and a stainless-steel plate on which a porous film was formed was immersed in an aqueous solution containing 2 mass % polyvinyl pyrrolidone and 2 mass % sodium erythorbate, followed by drying at room temperature, in order to form a coating film. Here, in the coating film, the content of polyvinyl pyrrolidone was controlled to 20 parts by mass with respect to 100 parts by mass of the silica fine particles, and the content of sodium erythorbate was controlled to 20 parts by mass with respect to 100 parts by mass of the silica fine particles.

Each of the stainless-steel plates prepared in Examples 4 and 8 to 11 was installed in an exhaust air duct in a kitchen and was kept there for half a year. Each stainless-steel plate was taken off from the exhaust air duct and washed with tap water. After that, the remaining oil stains were dissolved with hexane, and the resultant solution was collected and subjected to liquid chromatography to perform quantitative determination. Note that, in the case of each of the stainless-steel plates with a coating film prepared in Examples 4 and 11, the amount of oil stains before washing with tap water was also determined by liquid chromatography. Table 2 shows the results.

TABLE 2

| | | Amount of attached oil (mg/dm²) | |
|---|---|---|---|
| | | Before washing | After washing |
| | Antioxidant | with water | with water |
| Example 4 | — | 240 | 93 |
| Example 8 | Dibutylhydroxytoluene | — | 12 |
| Example 9 | Tocopherol | — | 9 |
| Example 10 | Hydroquinone | 205 | 27 |
| Example 11 | Sodium erythorbate | — | 39 |

As shown in Table 2, the results of the stainless-steel plate prepared in Example 4 showed that, after half a year passed, attached oil stains were difficult to remove by washing with water, but each of the stainless-steel plates prepared in Examples 8 to 11 showed that, even after half a year passed, attached oil stains were easily removed by washing with water. Therefore, it is possible to conclude that a coating film containing an antioxidant leads to the prevention of oxidation, etc., of oil stains, and even after a long period has passed, attached oil stains are easily removed by washing with water.

### Example 12

A coating composition was prepared by adding colloidal silica containing silica fine particles (inorganic fine particles) having an average particle diameter of 85 nm, colloidal silica containing silica fine particles (inorganic fine particles) having an average particle diameter of 5 nm, and PTFE particles (fluororesin particles) having an average particle diameter of 0.3 μm to deionized water, followed by mixing, and further adding polyoxyethylene lauryl ether (a surfactant) to the mixture, followed by mixing. Here, in the coating composition, the content of the silica fine particles having an average particle diameter of 85 nm was controlled to 3.5 mass %, the content of the silica fine particles having an average particle diameter of 5 nm was controlled to 1.2 mass %, and the content of the surfactant was controlled to 0.05 mass %. Further, the content of the PTFE particles was controlled to 15 parts by mass with respect 100 parts by mass of the total silica fine particles.

A stainless-steel plate was immersed in the resultant coating composition, slowly drawn up, and dried at 100° C. for 30 minutes, in order to form a porous film (film thickness: 1.5 μm). The stainless-steel plate on which the porous film was formed was immersed in an aqueous solution containing 1 mass % polyvinyl alcohol (GOHSEFIMER Z-200 manufactured by The Nippon Synthetic Chemical Industry Co., Ltd.). Next, the stainless-steel plate was drawn up from the aqueous solution, and the excess aqueous solution was shaken off, followed by drying at room temperature, in order to form a coating film filled with polyvinyl alcohol. Here, the content of polyvinyl alcohol in the coating film was controlled to 35 parts by mass with respect to 100 parts by mass of the silica fine particles.

### Example 13

A stainless-steel plate on which a coating film was formed was prepared in Example 13 in the same manner as that of Example 12, except that an aqueous solution prepared by using polyvinyl alcohol and adipic acid dihydrazide was used. Here, the amount of adipic acid dihydrazide blended in the aqueous solution was controlled to 1.5 parts by mass with respect to 100 parts by mass of polyvinyl alcohol.

### Comparative Example 4

A stainless-steel plate on which a coating film was formed was prepared in Comparative Example 4 in the same manner as that in Example 12, except that sorbitol, which is a water-soluble substance having a lower molecular weight, was used instead of polyvinyl alcohol. Here, the content of sorbitol in the aqueous solution was controlled to 5 mass %.

Each of the stainless-steel plates prepared in Examples 12 and 13 and Comparative Example 4 was exposed for 5 minutes to oil smoke produced by heating a vegetable oil on a hot plate, to produce oil stains. Then, the attached oil stains were dissolved with hexane, and the resultant solution was collected and subjected to liquid chromatography to perform quantitative determination. Next, each of the stainless-steel plates which were prepared in the same manner as described above and to which oil stains were attached was washed by pouring water at about 40° C. for about 10 seconds. After that, in the same manner as described above, the remaining oil stains were dissolved with hexane, and the resultant solution was collected and subjected to liquid chromatography to perform quantitative determination. The cycle including the attachment of oil stains and the washing thereof was repeated, that is, the second cycle, the third cycle, and the fourth cycle were performed. The amount of attached oil after each cycle was evaluated. Table 3 shows the results.

TABLE 3

| | Amount of attached oil (mg/dm²) | | | | |
|---|---|---|---|---|---|
| | | After | After | After | After |
| | Before washing | first | second | third | fourth |
| | with water | cycle | cycle | cycle | cycle |
| Example 12 | 85 | 7 | 11 | 29 | 31 |
| Example 13 | 91 | 8 | 9 | 19 | 18 |
| Comparative | 82 | 38 | 92 | 82 | 90 |
| Example 4 | | | | | |

As shown in Table 3, the results of each of the stainless-steel plates prepared in Examples 12 and 13 showed that, even after the fourth cycle, attached oil stains were easily removed by washing with water. In particular, the results of the stainless-steel plate prepared in Example 13 in which an aqueous solution prepared by using adipic acid dihydrazide serving as a cross-linking agent together with polyvinyl alcohol was used showed that, even after the fourth cycle, the amount of attached oil stains removed was remarkably high. In contrast, the results of the stainless-steel plate prepared in Comparative Example 4 showed that, as the number of the cycle increases, oil stains became more difficult to remove.

Next, the stainless-steel plate prepared in Example 6 was used to carry out the following experiments.

The stainless-steel plates was exposed for 5 minutes to oil smoke produced by heating a vegetable oil on a hot plate, thereby attaching oil stains thereto. Then, the attached oil stains were dissolved with hexane, and the resultant solution was collected and subjected to liquid chromatography to perform quantitative determination. Next, the stainless-steel plate which was prepared in the same manner as described above and to which oil stains were attached was washed by using an aqueous solution containing 2 mass % sorbitan lauryl ester. After that, in the same manner as described above, the remaining attached oil stains were subjected to liquid chromatography to perform quantitative determination.

The cycle including the attachment of oil stains and the washing thereof described above was repeated, that is, the second cycle, the third cycle, and the fourth cycle were performed. The amount of attached oil after each cycle was evaluated. Table 4 shows the results.

TABLE 4

| | Amount of attached oil (mg/dm²) | | | | |
|---|---|---|---|---|---|
| | | After | After | After | After |
| | Before washing | first | second | third | fourth |
| | with water | cycle | cycle | cycle | cycle |
| Example 6 | 98 | 8 | 12 | 20 | 12 |

As shown in Table 4, the results of the stainless-steel plate prepared in Example 6 showed that, even after the fourth cycle, attached oil stains were easily removed by washing with water. Further, it was found that washing with an aqueous solution containing the water-soluble substance replenished the water-soluble substance in the coating film, resulting in the effect of removing attached oil stains being maintained.

### Comparative Example 5

In Comparative Example 5, a coating film which was formed of inorganic fine particles and fluororesin particles but which was not filled with any water-soluble substance was produced. Here, a coating film formed of a porous film was formed on a stainless-steel plate in the same manner as that in Example 12, except that polyvinyl alcohol did not fill the porous film.

Next, each of the stainless-steel plates prepared in Examples 4, 5, and 12 and Comparative Example 5 were used to carry out the following experiment.

Each of the stainless-steel plates was exposed for 5 minutes to oiismoke produced by heating a vegetable oil on a hot plate, to produce oil stains. Then, the attached oil stains were dissolved with hexane, and the resultant solution was collected and subjected to liquid chromatography to perform quantitative determination. Next, each of the stainless-steel plates which were prepared in the same manner as described above and those to which oil stains were attached were lightly wiped twice with a towel cloth impregnated with water. After that, in the same manner as described above, the remaining attached oil stains were subjected to liquid chromatography to perform quantitative determination. Table 5 shows the results.

TABLE 5

Amount of attached oil
(mg/dm²)

| | Before wiping | After wiping |
|---|---|---|
| Example 4 | 25 | 12 |
| Example 5 | 76 | 9 |
| Example 12 | 92 | 15 |
| Comparative | 125 | 102 |
| Example 5 | | |

As shown in Table 5, the results of each of the stainless-steel plates prepared in Examples 4, 5, and 12 showed that attached oil stains were easily removed by wiping. In contrast, the results of the stainless-steel plate prepared in Comparative Example 5 showed that attached oil stains were not sufficiently removed by wiping.

As the above-mentioned results show, it is possible to form, by adopting the coating method of the present invention, a coating film which exhibits an excellent effect for inhibiting the attachment of oil stains for a long period and from which, even if oil stains are attached, the oil stains can be easily removed by wiping or washing with water.

Note that this international application claims priority based on Japanese Patent Application No. 2009-031673 filed on Feb. 13, 2009, the disclosure of which is incorporated herein by reference in its entirety.

1. A method of coating a material, the method comprising:
applying a coating composition comprising at least one inorganic fine particle and at least one fluororesin particle in an aqueous medium onto a material to be coated;
drying the coating composition on the material to be coated to remove the aqueous medium, thereby forming a porous film comprising the at least one inorganic fine particle, the porous film comprising the at least one fluororesin particle dispersed therein and having voids; and
applying a water-soluble polymer onto the porous film, thereby filling the voids of the porous film with the water-soluble polymer.

2. The method of claim 1, wherein the coating composition further comprises an antioxidant.

3. The method of claim 1, comprising applying the water-soluble polymer and an antioxidant onto the porous film, thereby filling the voids of the porous film with the water-soluble polymer and the antioxidant.

4. The method of claim 1, wherein a content of the at least one inorganic fine particle in the coating composition is 0.5 mass % to 60 mass %.

5. The method of claim 1, wherein a content of the at least one fluororesin particle in the coating composition is 5 parts by mass to 70 parts by mass with respect to 100 parts by mass of the at least one inorganic fine particle.

6. A coated article, comprising a coating film which comprises a porous film comprising at least one inorganic fine particle with at least one fluororesin particle dispersed in the porous film, and a water-soluble polymer filling voids of the porous film.

7. The article of claim 6, wherein the water-soluble polymer and an antioxidant fill the voids of the porous film.

8. The article of claim 6, wherein a content of the at least one fluororesin particle in the coating film is 5 parts by mass to 70 parts by mass with respect to 100 parts by mass of the at least one inorganic fine particle.

9. The article of claim 6, wherein an amount of the water-soluble polymer filling the coating film is 5 parts by mass to 120 parts by mass with respect to 100 parts by mass of the at least one inorganic fine particle.

10. The article of claim 7, wherein an amount of the antioxidant filling the coating film is 0.05 part by mass to 30 parts by mass with respect to 100 parts by mass of the at least one inorganic fine particle.

11. The method of claim 2, wherein a content of the at least one inorganic fine particle in the coating composition is 0.5 mass % to 60 mass %.

12. The method of claim 3, wherein a content of the at least one inorganic fine particle in the coating composition is 0.5 mass % to 60 mass %.

13. The method of claim 2, wherein a content of the at least one fluororesin particle in the coating composition is 5 parts by mass to 70 parts by mass with respect to 100 parts by mass of the at least one inorganic fine particle.

14. The method of claim 3, wherein a content of the at least one fluororesin particle in the coating composition is 5 parts by mass to 70 parts by mass with respect to 100 parts by mass of the at least one inorganic fine particle.

15. The method of claim 4, wherein a content of the at least one fluororesin particle in the coating composition is 5 parts by mass to 70 parts by mass with respect to 100 parts by mass of the at least one inorganic fine particle.

16. The article of claim 7, wherein a content of the at least one fluororesin particle in the coating film is 5 parts by mass to 70 parts by mass with respect to 100 parts by mass of the at least one inorganic fine particle.

17. The article of claim 7, wherein an amount of the water-soluble polymer filling the coating film is 5 parts by mass to 120 parts by mass with respect to 100 parts by mass of the at least one inorganic fine particle.

18. The article of claim 8, wherein an amount of the water-soluble polymer filling the coating film is 5 parts by mass to 120 parts by mass with respect to 100 parts by mass of the at least one inorganic fine particle.

19. The article of claim 8, wherein an amount of the antioxidant filling the coating film is 0.05 part by mass to 30 parts by mass with respect to 100 parts by mass of the at least one inorganic fine particle.

20. The article of claim 9, wherein an amount of the antioxidant filling the coating film is 0.05 part by mass to 30 parts by mass with respect to 100 parts by mass of the at least one inorganic fine particle.
